(19) United States
(12) Patent Application Publication
(10) Pub. No.: US 2024/0425387 A1
(43) Pub. Date: Dec. 26, 2024

(54) METHOD AND DEVICE FOR DESALINATING WATER

(71) Applicant: SEANERGY, Marseille (FR)

(72) Inventor: Siu Bun David Lam, Paris (FR)

(73) Assignee: SEANERGY, Marseille (FR)

(21) Appl. No.: 18/710,853

(22) PCT Filed: Nov. 16, 2022
(86) PCT No.: PCT/FR2022/052095

§ 371 Date: May 16, 2024

(30) Foreign Application Priority Data
Nov. 18, 2021 (FR) FR2112176

(51) Int. Cl. C02F 1/22; C02F 1/38; C02F 103/08

(52) U.S. Cl. CPC C02F 1/22; C02F 1/385; C02F 2103/08; C02F 2209/02

(57) ABSTRACT

A method for desalinating seawater includes a step of cooling an incoming seawater to a temperature of between −2 and 0 degrees Celsius, in order to obtain ice crystals suspended in a concentrated seawater. The method further includes a decantation step making it possible to have a first removal of concentrated seawater, a centrifugation step to separate the ice crystals from the concentrated seawater, a step of collecting ice crystals, and a step of obtaining a freshwater, by melting ice crystals.

### TECHNICAL FIELD

The present invention relates to a method and a device for desalinating seawater using, more specifically, a cryo-crystallisation method.

### TECHNOLOGICAL BACKGROUND

Water is more and more coveted through the world. Indeed, the demand for water has only increased over the last few years, and is intended to continue to grow strongly, in particular due to the needs of industry, energy, with, among others, the manufacture of hydrogen and also due to the increase of the population. That is why water has become a global issue. Yet, around ninety-seven percent of the water present on Earth is salty. Thus, the industrial development of freshwater, even pure water production through desalination methods has risen over the last few years.

Desalinating seawater makes it possible to obtain freshwater, even pure water, from briny or salty water, such as seawater or oceans having, on average, 35 grams of salt per litre of water. To date, there are two main methods used in seawater desalination stations. To this end, seawater can be desalinated, either by vaporising by thermal distillation, or by projecting it through an ultrafine membrane which retains salt by reverse osmosis.

Thermal distillation, the oldest method, consists of sieving seawater to remove its largest impurities, then to heat it until evaporation in tanks where salts are deposited. The evaporated water then passes into a condensation tank where it returns to a liquid form.

Reverse osmosis, the most commonly used method today, consists of carefully filtering seawater, via sand and charcoal layers. This makes it possible to remove microalgae and suspended particles, such that the salts only remain. The water is then projected under high pressure through very fine semi-permeable membranes. These membranes trap the salt and only let water molecules pass through.

However, these methods proven for desalinating seawater have several disadvantages, in particular, in terms of environmental impact. Indeed, thermal distillation uses a lot of energy. Reverse osmosis, itself, consumes less energy, but requires continually cleaning the membranes by using chemical products. However, the major environmental impact remains the discharge, most often into the sea, of effluents coming from factories using these desalination methods. The main feature of these discharged effluents is their high salinity, thus qualified as brine. Yet, when brine is discharged without dilution nor treatment, it induces an increase of the concentration of salt around the discharge zone being able to lead to modifications of the local environment, such as anoxia and/or the decrease of light at the ocean floor, thus affecting ocean ecosystems. At the same time, such effluents can contain chemical products, used for factory operation, and have a high temperature modifying the temperature of seawater at the brine discharge zone.

To respond to this problem, a method for desalinating seawater not causing brine discharge, is a major interest.

To this end, American patent U.S. Pat. No. 3,377,814 and patent application FR 2 334 627 disclose methods for producing freshwater by cryo-crystallisation. Seawater is cooled to form ice crystals. Ice crystals suspended in seawater are then separated from the seawater by decantation. The ice crystals are, subsequently, collected and transformed, by melting, into a liquid freshwater. However, such methods require a separation time by decantation which is relatively long, and very often incompatible with industrial needs and/or rates.

Patent application WO 2005/015008 discloses another method for producing freshwater by cryo-crystallation wherein the ice crystals suspended in water are separated by centrifugation. In this method, decantation is replaced by the passage into a centrifuge to separate the ice from the seawater. Such a method makes it possible to treat a greater volume of ice crystals, but requires a significant energy input to separate ice crystals.

### SUMMARY OF THE INVENTION

The present invention therefore aims to overcome the abovementioned disadvantages, in particular, to propose a method to extract freshwater from seawater by cryo-crystallisation by coupling decantation and centrifugation technologies. Freezing makes it possible to obtain both ice crystals having a high purity level and a residual seawater having a sodium concentration of a few parts per million. This concentration is less than that of the brine coming from desalination methods which are known and described above. The combination of decantation and centrifugation makes it possible, itself, to obtain a high flow rate while reducing the energy necessary to separate the ice crystals from the seawater.

To this end, the invention discloses, as a first aim, a method for desalinating seawater comprising a step of cooling an incoming seawater to a temperature of between −2 and 0 degrees Celsius in order to obtain ice crystals suspended in a concentrated seawater. Said method further comprises:
a decantation step making it possible to have a first removal of concentrated seawater,
a centrifugation step carried out after the decantation step to separate the ice crystals from the concentrated seawater;
a step of collecting ice crystals;
a step of obtaining freshwater, by melting ice crystals.

In order to reduce the necessary energy consumption, the step of cooling incoming seawater of said method can comprise a first step of cooling incoming seawater to a temperature substantially equal to 5 degrees Celsius and a second step of cooling incoming seawater to a temperature of between −2 and 0 degrees Celsius.

In order to have a closed, continuous method and thus to make energy savings, the first step of cooling incoming seawater can be carried out by heat exchange with the concentrated seawater, then with the collected ice crystals coming from the centrifugation step to cool the incoming seawater.

To avoid a too rapid melting of the ice crystals, the concentrated seawater containing the ice crystals can be maintained at a temperature of between −2 and 0 degrees Celsius during the decantation and centrifugation steps.

In a second aim, the invention discloses a device for desalinating seawater, comprising:
at least one cooler cooling an incoming seawater to a temperature of between −2 and 0 degrees Celsius, in order to generate ice crystals suspended in a concentrated seawater;
a decantation tray making it possible, by decantation, after generating ice crystals, to remove a first part of the concentrated seawater, -a refrigerated centrifuge, maintained at a temperature of between −2 and 0 degrees Celsius, said centrifuge receiving the concentrated seawater and the suspended ice crystals coming from at least one cooler, in order to separate the ice crystals from the concentrated seawater.

In a preferred embodiment making it possible to reduce the energy consumption necessary for the implementation of said device, the at least one cooler can comprise a first cooler cooling the incoming seawater to a temperature of 5 degrees Celsius and a second cooler consisting of an ice crystal generator cooling the incoming seawater of the first cooler to a temperature of −2 degrees Celsius.

Preferably, in order to increase productivity, the ice crystal generator can comprise a refrigerating tube and a rotary scraper which scrapes the internal walls of said tube, on which ice crystals are formed.

Preferably, the refrigerated centrifuge can comprise a tank with at least one rotated movable disc, in order to rotate the ice crystals and the concentrated seawater, the disc being connected to the tank by anti-friction bearings.

In a preferred embodiment, in order to increase the active surface of the centrifuge, the at least one movable disc can comprise a plurality of conic discs.

### BRIEF DESCRIPTION OF THE FIGURES

The invention will be best understood and other features and advantages of it will appear upon reading the description below of particular embodiments of the invention, given as illustrative and non-limiting examples, and making reference to the accompanying drawings, among which:

FIG. 1 shows a preferred example of an implementation of a device for desalinating seawater according to the invention,

FIG. 2 shows a flowchart representative of steps of the seawater desalination method according to the invention,

FIG. 3 shows a cross-sectional view of a centrifuge, about the axis of revolution of said centrifuge according to the invention,

### DETAILED DESCRIPTION

In order to simplify the description, one same reference is used in different figures to mean one same object. Thus, when the description mentions a referenced object, this object can be identified in several figures. Furthermore, the figures, as well as the description, are given as non-limiting examples of embodiments.

In the preamble, it is important to remind that a seawater, being salty, freezes at a temperature lower than a freshwater, having a very low salinity. Indeed, salt lowers the solidification temperature of water by a few degrees, according to the quantity of salt.

The solidification of water is the passage of a liquid state, unordered water molecules, in a solid state, water molecules arranged to the side of one another, in an ordered manner. In a so-called liquid state, freshwater and/or pure water has molecules which are relatively free to make movements with respect to one another: they are bonded to one another, then rapidly undo these bonds, and so on. By lowering the temperature of the freshwater and/or pure water to a temperature of between −2 and 0 degrees Celsius, the movements of the water molecules will slow down until stopping, the water molecules will come to be ordered and will thus be bonded sufficiently durably to one another, to freeze in ice form.

However, if water contains salt, such as is the case of a seawater EM1, containing both water molecules and salt ions, the process is different. In this regard, the volume of a salt ion is substantially equal to the volume of a water molecule. Yet, such ions enjoy the proximity of the water molecules. Thus, by sliding between the water molecules, the salt ions separate and deviate the water molecules from one another, locally disrupting the arrangement of the latter. The components of salt will be interposed between the water molecules, introducing disorder. Thus, such that seawater solidifies, this disorder must be compensated with a temperature lower than 0 degrees Celsius, as the lowering of temperature favours the arrangement of the molecules in order to form a solid. For example, a seawater containing substantially 35 grams of salt per litre solidifies at around −2 degrees Celsius. Consequently, at a temperature of between −2 and 0 degrees Celsius, only some of the water molecules of the seawater EM1, namely the water molecules not having salt ions in the proximity, will thus be able to crystallise. On the contrary, the salt ions will prevent, in their surrounding zone, the crystallisation of water molecules. Thus, by cooling the incoming seawater EM1 to a temperature of between −2 and 0 degrees Celsius, this has the effect of crystallising some of the freshwater contained in the seawater, thus forming ice crystals CG suspended in a seawater EM2 that is more concentrated in salt.

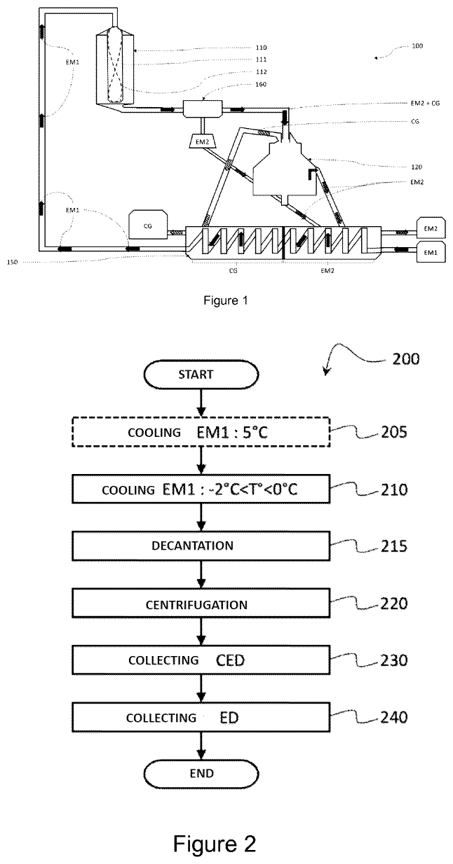

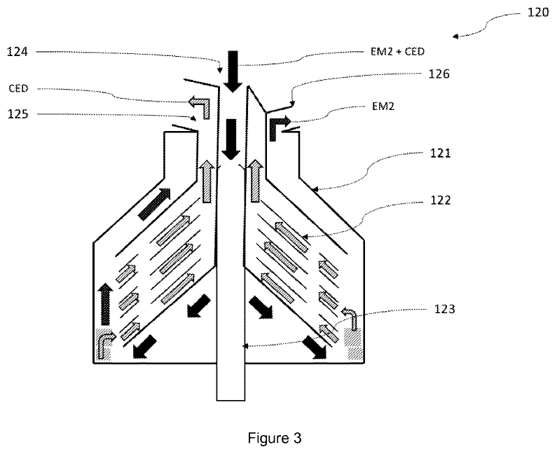

A preferred example of seawater desalination device 100, according to the invention, is represented in FIG. 1. Said seawater desalination device 100 is composed of at least one cooler 110, a decantation tray 160 and a refrigerated centrifuge 120 and is implemented by a method 200 for desalinating seawater, illustrated in the flowchart in FIG. 2. Said device 100 is thus implemented by said method 200 in order to desalinate a so-called incoming seawater EM1, sampled, preferably offshore, in the sea.

A first step 210 of said method 200 consists of cooling incoming seawater EM1. To do this, said incoming seawater EM1 is thus conveyed to the cooler 110. The communication between the seawater EM1 and the cooler 110 can be done by way of a pipe 113, such as illustrated in FIG. 1. However, a person skilled in the art can use any other type of water connection compatible with the use which is made of it within said device 100, such as, for example, a tap or a valve. It can also be considered that the incoming seawater EM1 is pre-filtered to remove possible contaminants.

The cooler 110 is sized to cool the incoming seawater EM1 to a temperature of between −2 and 0 degrees Celsius. Such a cooler 110 can consist, for example, of a refrigerating tube 111. Such a refrigerating tube 111 can be a hollow structure which receives and convey a refrigerant or otherwise called a refrigerant fluid. The refrigerant fluid can be any type of fluid being able to be used in a refrigeration device. Such a refrigerant fluid, flowing in said tube 111, makes it possible to lower the temperature of the latter to a temperature favouring the freezing of some of the incoming seawater EM1 in order to obtain the formation of ice crystals CG suspended in the concentrated seawater EM2. Thus, the temperature of the refrigerating tube 111 must be less than or equal to the freezing point of freshwater, but greater than that of salty seawater. As a reminder, such a temperature is between −2 and 0 degrees Celsius. As such, the refrigerating tube 111 can be made of a material which facilitates the transfer of heat.

As illustrative examples, such a material can be stainless steel, copper, aluminium, nickel, tin, or any other material, or any combination of these. Concentrated seawater EM2, in liquid phase, then leads to said formed crystals CG, towards the outlet of the cooler 110. However, the invention is not limited to the choice of the type of cooler 110, nor even to the types of elements of which it consists. A person skilled in the art can use any other type of cooler compatible with the use which is made of it within the invention, namely enabling at least one cooling of seawater EM1 to a temperature of between −2 and 0 degrees Celsius.

In a preferred embodiment, the cooler 110 can, preferably, consist of an ice crystal generator, making it possible to adjust the temperature of incoming seawater EM1 between −2 and 0 degrees Celsius. Such an ice crystal generator can be mainly composed of a refrigerating tube 111, enabling the formation of ice crystals CG, in particular on the walls of said tube 111 and of a rotary scraper 112 making it possible to detach said ice crystals CG from the walls of the refrigerating tube 111. This thus makes it possible to isolate a purified freshwater in solid form on the walls of said cooler 110. Said tube 111 and the scraper 112 can be in the vertical position or in the horizontal position. According to this preferred embodiment, the refrigerant fluid passes to the inside of the walls of said tube 111 or to the outside of the thermally conductive walls of said tube 111. The incoming seawater EM1, itself, passes through said tube 111. Ice crystals CG will be formed on all the refrigerated surfaces in contact with the liquid seawater EM1. However, the incoming seawater EM1 will tend to crystallise, preferably, on the walls of the refrigerating tube 111.

Said rotary scraper 112 scrapes, by mechanical action, all the internal walls of said refrigerating tube 111 in order to detach the ice crystals CG which are formed there to return them into the concentrated seawater EM2. Such a scraper 112 makes it possible to increase the crystallisation yield. Said scraper 112 is formed preferably of at least two blades disposed over the length of the scraper, such that said scraper 112 has a helical shape. However, the invention is not limited to the shape of the scraper, nor even to the tool and/or the way used to detach the ice crystals CG from the walls of the refrigerating tube 111. The ice crystals CG can be removed from the walls of said tube 111 in various ways, such as, for example, by gravity, with the use of a lever or even by thermally reducing the strength of the bond between the tube 111 and the ice crystals CG.

With such a cooler 110, it is possible to control the quantity of ice crystals CG suspended in the concentrated seawater EM2 by playing on the seawater EM1 flow rate passing through the cooler 110. As an example, a variation of the flow rate can make it possible to have a proportion of around 5% to 40% of ice crystals CG. In order to avoid a too high concentration of salt in the concentrated seawater, while ensuring a significant production of ice crystals, it is preferred to adjust the seawater flow rate to obtain, at the outlet of the cooler 110, around 10% of ice crystals for 90% of concentrated seawater EM2.

Once the cooling step 210 has been carried out and the ice crystals CG suspended in seawater EM2 have been obtained, a decantation step 215 is carried out, followed by a centrifugation step 220. The decantation step 2115 consists of carrying out a first removal of concentrated seawater EM2 before the centrifugation step 220, in order to reduce the volume to be treated by centrifugation.

The decantation step 215 uses natural separation, which is carried out when a solid is contained suspended in a liquid under the effect of gravity and of buoyancy. The decantation step 215 is carried out in the decantation tray 160, such as illustrated in FIG. 1. Such a tray 160 is sized to make it possible, by decantation, to remove a first part of the concentrated seawater EM2 obtained after passage into the cooler 110. Under the effect of gravity, the ice crystals CG will raise to the surface and a first part of the concentrated seawater EM2 will be removed from the mixture of ice crystals CG suspended in the concentrated seawater EM2 before passage into the centrifuge 120. An upwards intake will recover ice crystals CG suspended in the concentrated seawater EM2 which will then be conveyed towards the centrifuge 120. A downwards intake will recover a part of the concentrated seawater EM2 which does not contain any or hardly any ice crystals CG in order to discharge them into the sea.

According to the invention, and contrary to a decantation of the prior art, the decantation step does not aim to extract the ice crystals CG, but to extract a part of the concentrated seawater EM2. Due to this, it is not necessary to expect that the ice crystals CG raise completely to the surface, but only that they raise sufficiently into an upper part of the tray, while remaining suspended in the concentrated seawater EM2. Naturally, the temperature of the concentrated seawater EM2 and ice crystals CG mixture must be maintained at a temperature of between −2 and 0 degrees Celsius during decantation.

In order to accelerate decantation, such a decantation tray 160 can comprise a grille or a particle filter, in order to avoid the ice crystals CG going towards the intake of the bottom of said tray 160. A pump can also suction the concentrated seawater EM2 which is removed by the intake of the bottom. Thus, the decantation can be forced at the removal of concentrated seawater EM2, and it is possible to remove up to 90% of the concentrated seawater EM2, which makes it possible to considerably reduce the volume of concentrated seawater and of ice crystals to be treated during the centrifugation step 220.

The centrifugation step 220 consists of separating ice crystals CG formed from the concentrated seawater EM2, due to their density difference, by subjecting them to a centrifugal force. Separation by centrifugation is also known, in particular for creaming milk or even for separating a solid in a liquid according to their density. This same principle is applied to step 220 of said method 200 according to the invention in order to make it possible to accelerate the separation of the ice crystals CG from the concentrated seawater EM2. Indeed, any solid contained in a liquid is subjected to gravity, a force which is exerted from the top to the bottom, and to buoyancy, a force which is exerted from the bottom to the top. Thus, over time, a solid suspended in a liquid finishes, either by falling to the bottom of the container, in which it is located, either by raising to the surface according to its mass density with respect to that of the liquid. Yet, the carrying out of such a centrifugation step 220 makes it possible to accelerate this natural separation phenomenon. In the case of a centrifugation process, the separation speed Vz is governed by Stokes law:

$$Vz - \frac{{Zr}^{2} g Δρ}{9 η} ;$$

where r is the radius of the suspended solid, 66 ρ is the density difference between the suspended solid and the liquid containing the suspended solid, g is the acceleration due to the centrifugal force in the centrifuge and η is the viscosity of the liquid.

To do this, such as illustrated in FIG. 1, the ice crystals CG suspended in the concentrated seawater EM2 passes into the refrigerated centrifuge 120, maintained at a temperature between −2 and 0 degrees Celsius. The ice crystals CG have a density substantially equal to 0.9168 grams per millilitre. Between −2 and 0 degrees Celsius, such crystals CG are lighter than the concentrated seawater EM2 which has a density substantially equal to 1.0273 grams per millilitre. Thus, subjected to the centrifugal force combined with gravity, the ice crystals CG, lighter than the concentrated seawater EM2, will be projected and attracted upwards and the centre of the refrigerated centrifuge 120 along a modified gravity diagonal, while the concentrated seawater EM2 will be projected towards the periphery of the centrifuge 120.

The centrifuge 120 is thus sized to separate the ice crystals CG from the concentrated seawater EM2 at a temperature of between −2 and 0 degrees Celsius. Such as illustrated in FIG. 3, such a centrifuge 120 is composed of a tank 121 having refrigerated fixed walls and partitions and comprising a central axis of rotation 123 making it possible to reach a high rotation speed. For example, the rotation speed of said centrifuge 120, in the case of the invention, can be between 1000 and 5000 revolutions per minute. In order to maintain a temperature of between −2 and 0 degrees Celsius, the tank 121 can be refrigerated, for example, by way of an outer cooler which surrounds said tank 121. However, the invention is not limited to the means used to cool said tank 121 in order to maintain it between −2 and 0 degrees Celsius: any other equivalent means can be used. In addition, to limit energy losses, it is favoured to use relatively neutral and insulating materials for designing the centrifuge 120. Thus, as an example, the tank 121 can be made of stainless steel and/or made of reinforced composite material.

In a favoured embodiment, in order to facilitate separation by centrifugation, the tank 121 of the refrigerated centrifuge 120 can comprise one or more movable discs 122 which are rotated at the central axis of rotation 123 of the tank 121. Each disc 122 is connected to the tank 121 by bearings in order to support and guide said disc 122 in rotation. To avoid any heating within the tank 121, such bearings can be preferably anti-friction bearings such as polytetrafluoroethylene (referred to as PTFE)-based bearings. In a variant, a person skilled in the art can use any other type of material for the anti-friction bearings such as, for example, polyester-, and/or polyetheretherketone (referred to as PEEK)-based materials.

To ensure a better separation yield, it is preferably to have several rotary movable discs 122 stacked on top of one another having, preferably, a conic shape. In this regard, the tank 121 comprises a set of discs disposed parallel with a cone angle, corresponding to the inclination of the centrifugal force combined with gravity, making it possible to increase the separation speed. The conic shape makes it possible to guide the ice crystals CG according to the combined force of the centrifugal force and gravity. Such as illustrated in FIG. 3, the tank 121 comprises an inlet 124 through which the mixture of ice crystals CG and the concentrated seawater EM2 flow, into the outlet of the cooler 110. Said mixture will then circulate through the discs 122. The separation between the ice crystals CG and the concentrated seawater EM2 is carried out at each stacked disc 122. Under the impact of the centrifugal force, the heaviest component, namely the concentrated seawater EM2, will be deposited radially towards the outer partitions of the tank 121 to emerge at a first outlet 126 of the centrifuge 120. The lightest components, namely the ice crystals CG, will be moved upwards and towards the central axis of rotation 123 of the tank 121. The ice crystals will then emerge at a second outlet 125 of said centrifuge 120. Thus, the concentrated seawater EM2 flows from the periphery of the centrifuge 120 towards the first outlet 126, while the ice crystals move from the central part of the centrifuge 120 to the second outlet 125.

Such a centrifugation step 220 thus makes it possible to obtain both ice crystals CG corresponding, for example, to 10% of the incoming seawater EM1 and to both a concentrated seawater EM2 thus having a concentration of salt increased substantially by 11% with respect to the incoming seawater EM1. As an example, for an incoming seawater EM1 comprising 35 grams of salt per litre, such an increase of 11% brings the concentrated seawater EM2 to a concentration of around 38 grams of salt per litre, which is very acceptable with respect to brine having clearly greater salt contents. Complementarily, it is possible to adjust the concentration of salt of the concentrated seawater EM2 according to the flow rate of said device 100, but also according to the salt content of the incoming seawater EM1.

Such as illustrated in FIG. 2, after this centrifugation step 220, a step 230 of collecting ice crystals CG ensues. To do this, the ice crystals CG can be, for example, collected in a tray maintained at ambient temperature. Thus, a step 240 of obtaining a freshwater ED is thus carried out by melting ice crystals CG. At the same time, the concentrated seawater EM2 is discharged into the sea.

According to a particular embodiment of the invention illustrated in FIGS. 1 and 2, in order to reduce the energy consumptions, it is possible to carry out an additional step 211 of cooling the seawater EM1, prior to the cooling step 210. Preferably, such a step 211 consists of cooling the incoming seawater EM1 to a temperature substantially equal to 5 degrees Celsius. To do this, it can be considered to introduce a heat exchanger 150 within said device 100, prior to the cooler 110. Thus, such a heat exchanger 150 is, itself, sized to cool the incoming seawater EM1 to a temperature of 5 degrees Celsius before said seawater EM1 is conveyed to the cooler 110 which will enable it a thermal regulation of the incoming seawater EM1 between −2 and 0 degrees Celsius.

The heat exchange is carried out by using, initially, the concentrated seawater EM2 after the removal of the ice crystals CG, then secondly, by using the ice crystals CG collected from the centrifugation step 220. Thus, the incoming seawater EM1, hotter than the concentrated seawater EM2 and that the ice crystals CG coming from the decantation 215 and centrifugation 220 steps, will heat the seawater EM2 and the ice crystals CG while losing calories. Thus, the incoming seawater EM1 will, naturally, be cooled.

To do this, the heat exchanger 150 can comprise a coil-shaped tube immersed in a tray containing the concentrated seawater EM2 after the removal of the ice crystals CG and/or in a tray containing the ice crystals CG collected from the centrifugation 220. For effectiveness, it is preferable to do both, namely a passage into the tray containing the seawater EM2, then a passage into the tray containing the ice crystals CG, or vice versa. Said immersed tube comprises an inlet receiving the incoming seawater EM1, for example from a pump, and an outlet connected to the cooler 110. Thus, the incoming seawater EM1 will return inside of the immersed tube and will circulate inside said tube. During the passage of the seawater EM1, circulating in said tube, in the tray containing the concentrated seawater EM2 after removal of the ice crystals CG, said incoming seawater EM1, hotter, will lose calories, be cooled and also heat the concentrated seawater EM2. This makes it possible to lower the temperature of the incoming seawater EM1, but also to move closer to the temperature of the concentrated seawater EM2 from the temperature of the sea. In a variant or complementarily, the concentrated seawater EM2 can be heated naturally by the sun before being discharged into the sea. This has the effect of limiting too high temperature differentials between the discharged concentrated seawater EM2 and the sea. Subsequently, during the passage of the incoming seawater EM1, flowing in said tube, in the tray containing the ice crystals CG, the incoming seawater EM1 will again lose calories, will also lower its temperature and will heat the ice crystals CG. This makes it possible to once again lower the temperature of the incoming seawater EM1, but also accelerate the melting of the ice crystals CG in order to obtain the liquid freshwater ED.

Once the heat exchange has been carried out, the incoming seawater EM1 will be recovered at the outlet to be conveyed to the cooler 110 and thus be adjusted to a temperature of between −2 and 0 degrees Celsius. The heat exchanger 150 can be sized to make it possible to reach, as close as possible, the temperature sought for the incoming seawater EM1 before its passage into the cooler 110: such a temperature depending on the length of the tube. However, the invention is not limited to the type of heat exchanger used. A person skilled in the art can use any other type of heat exchanger compatible with the use which is made of it within the invention.

It will be appreciated by a person skilled in the art that the present disclosure is not limited to what is particularly shown and described above. Other modifications can be considered, without moving away from the scope of the present invention defined by the accompanying claims.

1. A method for desalinating seawater comprising a step of cooling an incoming seawater to a temperature of between −2 and 0 degrees Celsius, in order to obtain ice crystals suspended in a concentrated seawater, wherein the method comprises:
a decantation step making it possible to have a first removal of concentrated seawater,
a centrifugation step carried out at a temperature comprised after the decantation step to separate the ice crystals from the concentrated seawater;
a step of collecting ice crystals;
a step of obtaining a freshwater, by melting ice crystals.

2. A method for desalinating seawater according to claim 1, wherein the step of cooling the incoming seawater comprises a first step of cooling the incoming seawater to a temperature substantially equal to 5 degrees Celsius and a second step of cooling the incoming seawater to a temperature of between −2 and 0 degrees Celsius.

3. A method for desalinating seawater according to claim 2, wherein the first step of cooling the incoming seawater is carried out by heat exchange with the concentrated seawater, then with the ice crystals collected from the centrifugation step to cool the incoming seawater.

4. A method for desalinating the seawater according to claim 1, wherein the concentrated seawater containing the ice crystals is maintained at a temperature of between −2and 0 degrees Celsius during the decantation and centrifugation steps.

5. A seawater desalination device, further comprising:
at least one cooler (110, 150) cooling an incoming seawater to a temperature of between −2 and 0 degrees Celsius, in order to generate ice crystals suspended in a concentrated seawater;
a decantation tray making it possible, by decantation, after generating ice crystals, to remove a first part of the concentrated seawater;
a centrifuge refrigerated in order to be maintained at a temperature of between −2 and 0 degrees Celsius, said centrifuge receiving the concentrated seawater and the suspended ice crystals coming from the decantation tray after removal of a part of the concentrated seawater, in order to separate the ice crystals from the concentrated seawater.

6. A seawater desalination device according to claim 5, wherein the at least one cooler comprises a first cooler cooling the incoming seawater to a temperature of 5 degrees Celsius and a second cooler consisting of an ice crystal generator cooling the incoming seawater of the first cooler to a temperature of −2 degrees Celsius.

7. A seawater desalination device according to claim 6, for which the first cooler is a heat exchanger giving energy to the ice crystals and to the concentrated seawater exiting from the centrifuge to cool the incoming seawater.

8. A seawater desalination device according to claim 6, for which the ice crystal generator comprises a refrigerating tube and a rotary scraper which scrapes the internal walls of said tube on which the ice crystals are formed.

9. A seawater desalination device according to claim 5, for which the refrigerated centrifuge comprises a tank with at least one movable disc rotated in order to rotate the ice crystals and the concentrated seawater, the disc being connected to the tank by anti-friction bearings.

10. A seawater desalination device according to claim 9, for which the at least one movable disc comprises a plurality of conic discs.
